(19) United States
(12) Patent Application Publication
(10) Pub. No.: US 2021/0304292 A1
(43) Pub. Date: Sep. 30, 2021

(54) INFORMATION PROVIDING SYSTEM, CONTROL METHOD OF INFORMATION PROVIDING DEVICE, AND RECORDING MEDIUM

(71) Applicant: HONDA MOTOR CO., LTD., Tokyo (JP)

(72) Inventor: Ryo Saiki, Wako-shi (JP)

(21) Appl. No.: 17/208,118

(22) Filed: Mar. 22, 2021

(30) Foreign Application Priority Data
Mar. 27, 2020 (JP) 2020-058075

(51) Int. Cl. G06Q 30/06; H04L 29/08; B60Q 1/50; G06Q 20/12

(52) U.S. Cl. CPC G06Q 30/0641; G06Q 20/12; B60Q 1/50; H04L 67/125

(57) ABSTRACT

An information providing device includes a content acquisition unit for acquiring content data from a content distribution server, a content reproduction unit for reproducing and outputting the content data, a transaction screen acquisition unit for acquiring display information on a transaction screen for trading a transaction object including a product or service related to the content data, a display unit for displaying the transaction screen based on the display information, and a reception unit for receiving a transaction request based on the transaction screen, wherein the transaction screen is a screen in a specific form independent of a type and contents of the transaction object.

### INCORPORATION BY REFERENCE

The present application claims priority under 35 U.S.C. § 119 to Japanese Patent Application No. 2020-058075 filed on Mar. 27, 2020. The content of the application is incorporated herein by reference in its entirety.

### BACKGROUND OF THE INVENTION

### Field of the Invention

The present invention relates to an information providing system, a control method of the information providing device, and a recording medium.

### Description of the Related Art

Conventionally, a device has been proposed that acquires information on a product contained in contents of a television or radio broadcast in parallel with the broadcast and enables purchase of the product (for example, see Japanese Patent Laid-Open No. 2003-316980). In Japanese Patent Laid-Open No. 2003-316980, a car navigation device accesses an information disclosure server to acquire product information related to a broadcast which a user is listening to on a car radio, and displays it on a display.

As described in Japanese Patent Laid-Open No. 2003-316980, if access is made to a different information disclosure server for each broadcasting station which the user is listening to, a form of information obtained from the server may differ for each broadcasting station. In such a case, since a user interface for the user to purchase a product cannot be unified, operability may be lowered.

The present invention has been made in view of such background, and an objective is to provide a user interface with excellent operability regarding users' purchasing behavior.

### SUMMARY OF THE INVENTION

As a first aspect for achieving the above objective, there is mentioned an information providing system comprising a content distribution server for distributing content data and at least one movable body terminal device configured to be able to communicate with the distribution server and installed on a movable body, wherein: the movable body terminal device includes a terminal device-side processor, wherein the terminal device-side processor functions as a content acquisition unit for acquiring the content data, and a content reproduction unit for reproducing and outputting the content data; and the distribution server includes a server-side processor, wherein the server-side processor functions as an information acquisition unit for acquiring transaction information for trading at least one transaction object including a product or service related to the content data, and a transaction screen generation unit for generating a transaction screen enabling trading of the transaction object based on the transaction information, wherein: the terminal device-side processor functions as a display unit for displaying the transaction screen on a display provided on the movable body terminal device, and a reception unit for receiving a transaction request based on the transaction screen; and the server-side processor generates the transaction screen in a specific form independent of a type and contents of the transaction object by a function of the transaction screen generation unit.

In the information providing system, the configuration may be that the terminal device-side processor displays the transaction screen on the display in a state where the movable body is stopping and stops displaying the transaction screen while the movable body is moving.

In the information providing system, the configuration may be that: the content data includes transaction object information indicating a name or type of the transaction object; the transaction screen is a screen in which the transaction information for trading the transaction object related to the transaction object information is disposed in the specific form; and the terminal device-side processor does not display the transaction screen on the display after a preset display period has passed since the transaction object information included in the content data was reproduced by a function of the content reproduction unit.

In the information providing system, the configuration may be that the terminal device-side processor acquires information specifying the display period together with the transaction screen.

In the information providing system, the configuration may be that: the transaction information acquired by the server-side processor by a function of the information acquisition unit includes information indicating an upper limit quantity of the transaction object; the information providing system includes the plurality of movable body terminal devices; and the server-side processor functions as a transaction quantity counting unit for counting a transaction quantity of the transaction requests which the terminal device-side processors of the plurality of movable body terminal devices have received by the reception unit, and a transaction restriction unit for restricting the transaction requests to be received by the movable body terminal devices by the reception unit when the transaction quantity counted by the transaction quantity counting unit reaches the upper limit quantity of the transaction information.

In the information providing system, the configuration may be that: the transaction screen includes a first transaction screen and a second transaction screen, wherein the first transaction screen is a screen in which the transaction information on one of the transaction objects is disposed in the specific form, and the second transaction screen is a screen in which the transaction information on the plurality of transaction objects is displayed as a list; and the terminal device-side processor displays the first transaction screen on the display when the movable body stops from a moving state, and displays the second transaction screen on the display when the movable body is estimated to continue stopping.

In the information providing system, the configuration may be that the terminal device-side processor displays the transaction information on the transaction object for which the transaction request is not accepted on the second transaction screen together with information indicating that the transaction request is not accepted.

As a fourth aspect for achieving the above objective, there is mentioned a control method of an information providing device executed by a processor of the information providing device installed on a movable body, the control method of the information providing device comprising: acquiring content data from a content distribution server that distributes the content data; reproducing and outputting the content data; acquiring display information on a transaction screen for trading a transaction object including a product or service related to the content data; displaying the transaction screen on a display based on the display information; and receiving a transaction request based on the transaction screen, wherein the transaction screen displayed on the display is a screen in a specific form independent of a type and contents of the transaction object.

As a fifth aspect for achieving the above objective, there is mentioned a recording medium non-temporary, computer-readable, and having recorded a control program of an information providing device executed by a processor of the information providing device disposed on a movable body, wherein the control program causes the processor to: acquire content data from a content distribution server that distributes the content data; reproduce and output the content data; acquire display information on a transaction screen for trading a transaction object including a product or service related to the content data; display the transaction screen on a display based on the display information; and receive a transaction request based on the transaction screen, wherein the transaction screen displayed on the display is a screen in a specific form independent of a type and contents of the transaction object.

### Advantageous Effect of Invention

According to the above configurations, since the transaction screen that enables trading of the transaction object related to content data is in the specific form independent of the type and contents of the transaction object, the user can easily recognize information displayed on the transaction screen. This makes it possible to provide a user interface with excellent operability when a product or service of the transaction object is traded.

### BRIEF DESCRIPTION OF THE DRAWINGS

FIG. 1 is an explanatory diagram illustrating an outline of an information providing system;

FIG. 2 is a sequence diagram illustrating operation of the information providing system;

FIG. 3 is a configuration diagram of an information providing device;

FIG. 4 is a block diagram of an information providing server;

FIG. 5 is a flowchart illustrating operation of the information providing device;

FIG. 6 is a flowchart illustrating operation of the information providing device;

FIG. 7 is a flowchart illustrating operation of the information providing device;

FIG. 8 is a flowchart illustrating operation of the information providing server;

FIG. 9 is a flowchart illustrating operation of the information providing server;

FIG. 10 is a diagram illustrating an example of a purchase screen; and

FIG. 11 is a diagram illustrating an example of a purchase list screen.

### DETAILED DESCRIPTION OF THE PREFERRED EMBODIMENTS

### 1. Outline of Information Providing System

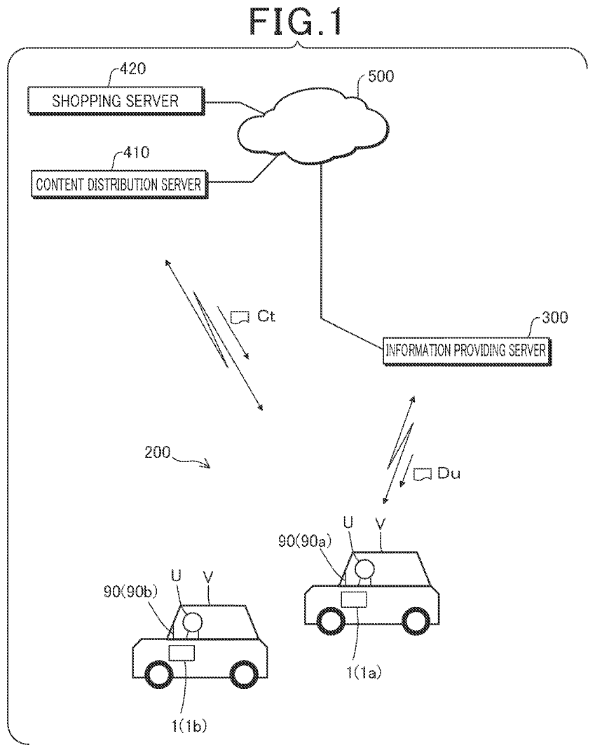

An outline of an information providing system 200 of an embodiment will be described with reference to FIG. 1.

The information providing system 200 is a system in which an information providing device 1 mounted on a vehicle V communicates with an information providing server 300 via a communication network 500, and provides a user U on board the vehicle V with a user interface through which a product or service can be purchased. The vehicle V is an example of a movable body.

In the information providing system 200, the information providing server 300 and one or more information providing devices 1 can communicate with each other. FIG. 1 shows an example in which information providing devices 1a and 1b are mounted on two respective vehicles V and the information providing devices 1a and 1b each communicate with the information providing system 200. In the following description, when the information providing devices 1a and 1b are not distinguished, they are referred to as the information providing device 1. The number of information providing devices 1 used in the information providing system 200 is not limited.

The information providing device 1 receives content data Ct from a content distribution server 410 in response to an operation of the user U who uses the vehicle V. The content data Ct includes audio data, video data, image data, or the like. The content distribution server 410 distributes the content data Ct by streaming through the communication network 500, for example, in response to a request from the information providing device 1. In the embodiment, as the content data Ct reproducible even when the vehicle V is running, audio data of radio broadcasting is taken as an example. Here, the radio broadcasting is broadcasting distributed by data communication through the communication network 500, such as Internet radio or podcast, and may be broadcasting using radio waves, such as AM broadcasting and FM broadcasting. The user U operates the information providing device 1, thereby specifies a channel or broadcasting station of the content data Ct, and can view or listen to the content data Ct.

The information providing server 300 communicates with the content distribution server 410 and a shopping server 420 through the communication network 500. In the following description, purchasing a product, receiving a service by paying for consideration, and applying for those are collectively referred to as transactions. A product and a service that are to be traded are called transaction objects. The transactions in the embodiment include at least designation of a transaction object and payment of consideration or reservation of payment of consideration.

The content distribution server 410 is a server operated by a business operator that distributes the content data Ct, and its main function is to distribute the content data Ct. The content distribution server 410 does not sell the product or service, but has information indicating the product or service related to the content data Ct being distributed. For example, audio included in the content data Ct may include a product name, a name of a type of product, a service name, a name of a type of service, or the like. When the user U knows the name of the product or service by the audio of the content data Ct, the user may be interested in the product or service. In this way, the product or service related to the content data Ct is set as the transaction object, in the information providing system 200.

The shopping server 420 is a server for trading the product or service, and provides so-called online shopping. The shopping server 420 provides information, such as a product name, a service name, a transaction quantity, and a price for the transaction object, and receives applications for the transactions. The shopping server 420 may operate integrally with the content distribution server 410.

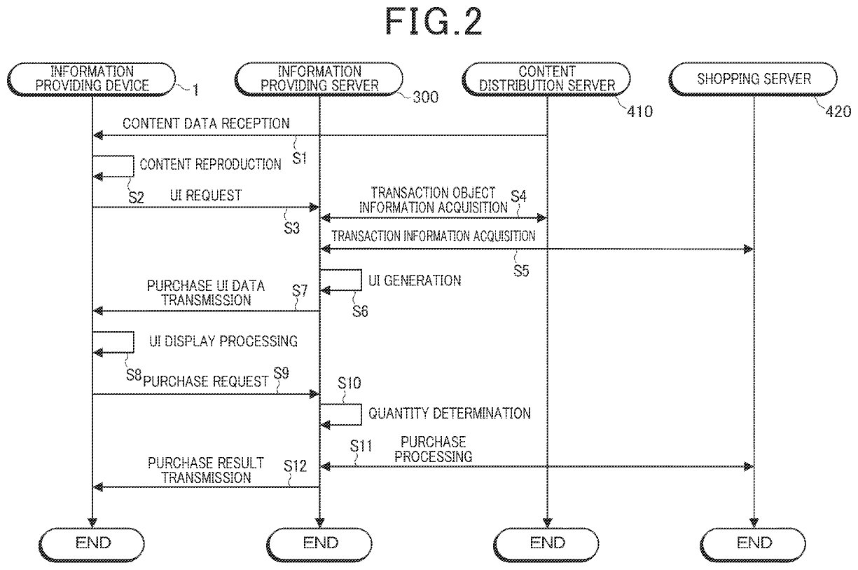

FIG. 2 is a sequence diagram illustrating an outline of operation of the information providing system 200, and shows operation of each of the information providing server 300, content distribution server 410, and shopping server 420.

The information providing device 1 receives the content data Ct from the content distribution server 410 according to the operation of the user U (step S1). The information providing device 1 reproduces and outputs video and audio based on the content data Ct (step S2).

The information providing device 1 requests the information providing server 300 to provide a user interface to purchase the product or service related to the content data Ct being received (step S3).

The information providing server 300 receives the request from the information providing device 1, accesses the content distribution server 410, and acquires transaction object information (step S4).

The transaction object information is information that identifies or can identify the transaction object related to contents of the content data Ct distributed by the content distribution server 410. For example, when images, audio, or characters of the content data Ct include the product name, the name of the type of product, the service name, the name of the type of service, or the like, these are an example of the transaction object information. The transaction object information may be abstract information.

The information providing server 300 accesses the shopping server 420 based on the transaction object information acquired in step S4, and selects or identifies a transaction object corresponding to the transaction object information among transaction objects handled by the shopping server 420. The information providing server 300 acquires transaction information including the product name, service name, quantity, price, and the like of the selected or identified transaction object from the shopping server 420 (step S5). The quantity included in the transaction information includes a transaction unit quantity of one transaction and an upper limit quantity until which the shopping server 420 can provide. For example, transaction information related to sales of a product includes a quantity of the product purchased at one transaction and an upper limit quantity until which the shopping server 420 can sell the product. The upper limit quantity is the total of transactions with all users U processed by the information providing server 300. In this example, when the quantity of transactions received by the information providing server 300 reaches the upper limit quantity, the shopping server 420 does not conduct transaction after that. For this reason, the information providing server 300 limits purchase requests received from all the information providing devices 1 including the information providing devices 1a and 1b so as not to exceed the upper limit quantity included in the transaction information, as described later.

The information providing server 300 generates a user interface including a purchase screen to be displayed by the information providing device 1 based on the transaction information acquired from the shopping server 420 (step S6). The information providing server 300 transmits purchase UI data including the generated user interface to the information providing device 1 (step S7).

The information providing device 1 displays the purchase screen, which is a user interface for purchase, on the touch panel 90 based on the purchase UI data transmitted by the information providing server 300 (step S8).

The information providing device 1 requests the information providing server 300 to purchase the transaction object in response to an operation of the user U on the purchase UI (step S9). Here, the information providing server 300 determines whether the purchase request from the information providing device 1 does not reach the upper limit included in the transaction information (step S10). The information providing server 300 performs a process of purchasing the transaction object for the shopping server 420 (step S11), and notifies the information providing device 1 of a result of the process (step S12).

The touch panel 90 to be mounted is mounted on the vehicle V. The touch panel 90 has a configuration in which the display screen and a touch sensor for detecting a touch operation are overlapped, displays various screens according to control of a control unit 10 described later, and receives the touch operation by the user U.

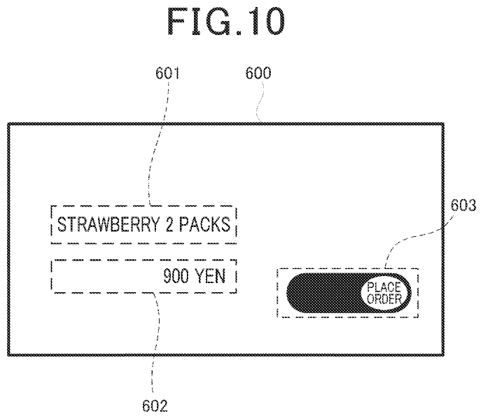

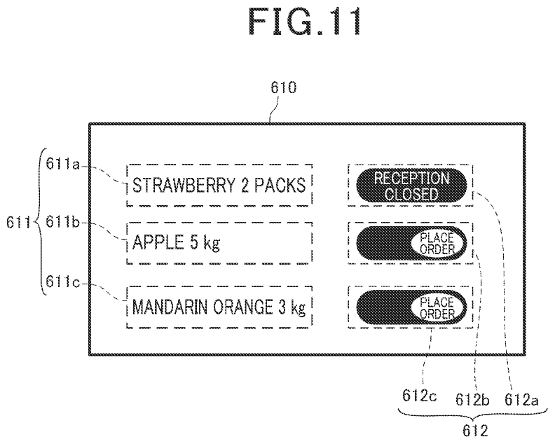

The information providing device 1 displays the purchase screen on the touch panel 90 based on the purchase UI data generated by the information providing server 300 as described later. The purchase screen is an example of the transaction screen enabling trading of the transaction object, and includes a purchase screen 600 (FIG. 10) and a purchase list screen 610 (FIG. 11) as described later. The purchase screen 600 corresponds to an example of a first transaction screen, and the purchase list screen 610 corresponds to an example of a second transaction screen. The user U can purchase the product or service, which are transaction objects, by performing the touch operation to the touch panel 90 in a state where the purchase screen is displayed. When the user U is driving the vehicle V, the user U can gaze at the touch panel 90 while the vehicle V is stopping, but the time is limited. Therefore, the purchase screen is desired to have a configuration in which the user U can quickly visually recognize the name, price, or the like of the product or service, and apply for purchase with a simple operation.

The number of content distribution servers 410 that distribute the content data Ct to the information providing device 1 is not limited, and the information providing device 1 can select one content distribution server 410 from the plurality of content distribution servers 410 and receive the content data Ct. The numbers of content distribution servers 410 and shopping servers 420 which the information providing server 300 accesses are not limited either. For example, the information providing server 300 may access a plurality of shopping servers 420 in order to acquire transaction information related to one piece of content data Ct, and acquire the transaction information from one or more shopping servers 420.

In general, configurations of webpages for online shopping are different by business operators who operate websites. Therefore, formats of the transaction information provided by the shopping servers 420 may also be different for each shopping server 420. The transaction information provided by all the shopping servers 420 commonly includes basic information, such as the product name or service name, price, and transaction unit quantity, but a display form when it is displayed on the touch panel 90 or the like is not always common.

In the information providing system 200, the information providing server 300 generates the user interface including the purchase screen based on the transaction information acquired from the shopping servers 420. Therefore, the configuration of the purchase screen can be standardized regardless of the shopping servers 420 or transaction objects, and the user interface having excellent operability can be provided.

Hereinafter, configurations of the information providing device 1 and information providing server 300 included in the information providing system 200 will be described in detail.

### 2. Configuration of Information Providing Device

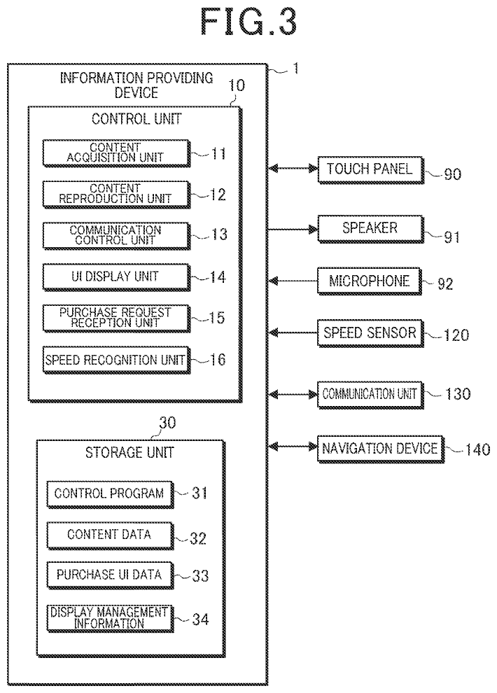

FIG. 3 is a configuration diagram of the information providing device 1. The configuration shown in FIG. 3 is common to the information providing device 1a and information providing device 1b.

The information providing device 1 is connected to the touch panel 90, the speaker 91, a microphone 92, a speed sensor 120, a communication unit 130, and a navigation device 140 which the vehicle V is equipped with.

The touch panel 90, speaker 91, and microphone 92 are installed, for example, on a dashboard in the interior of the vehicle V. The touch panel 90 is disposed, for example, at a position where the user U who sits in a driver's seat or passenger seat of the vehicle V can easily operate. The speaker 91 outputs audio in the interior of the vehicle V. A plurality of speakers 91 may be disposed in the interior of the vehicle V. The microphone 92 is preferably disposed at a position where voice uttered by the user U seated in the driver's seat or passenger seat can be collected.

The speed sensor 120 detects traveling speed of the vehicle V. The communication unit 130 (receiver/transmitter) includes an antenna and wirelessly communicates with the content distribution server 410 and information providing server 300. The navigation device 140 includes a GPS (Global Positioning System) sensor (not shown) and map data, and executes route guidance to a destination and the like based on a position of the vehicle V detected by the GPS sensor and the map data. The communication unit 130 corresponds to an example of a movable body communication unit. The communication unit 130 may form part of the information providing device 1.

A voice signal of the voice collected by the microphone 92, a touch position detection signal of the touch panel 90, a speed detection signal of the speed sensor 120, and information on the current position (latitude and longitude) of the vehicle V detected by the navigation device 140 are input to the information providing device 1.

Screen display of the touch panel 90 and audio output from the speaker 91 are controlled by a control signal output from the information providing device 1.

The information providing device 1 includes a control unit 10 for controlling each unit of the information providing device 1 and a storage unit 30 having a program and data stored therein. The control unit 10 executes a control program 31 stored in the storage unit 30 by a processor such as a CPU (Central Processing Unit) or microcomputer, and implements various functions of the information providing device 1. FIG. 3 shows, as functional units configured by the control unit 10, a content acquisition unit 11, a content reproduction unit 12, a communication control unit 13, a UI display unit 14, a purchase request reception unit 15, and a speed recognition unit 16. These functional units are implemented by collaboration of software and hardware, for example, by the processor executing the program. The control unit 10 may be equipped with hardware corresponding to those functional units. The control unit 10 may include an interface circuit (not shown).

The storage unit 30 (recording medium) is composed of a semiconductor memory or magnetic recording device, and has stored therein a program and data in a non-volatile manner. The storage unit 30 has stored therein content data 32, purchase UI data 33, and display management information 34, in addition to the control program 31.

The content acquisition unit 11 accesses the content distribution server 410 in order to acquire content specified by the operation of the user U, and receives the content data Ct by the communication unit 130. The content acquisition unit 11 generates the content data 32 from the received content data Ct, and stores it in the storage unit 30.

The content reproduction unit 12 reproduces the content data 32. In the embodiment, the content reproduction unit 12 reproduces audio data based on the content data 32 and outputs audio from the speaker 91.

The communication control unit 13 controls the communication unit 130 to perform reception of the content data Ct, reception of the purchase UI data from the information providing server 300, transmission of the request to the information providing server 300, and the like. The communication control unit 13 stores the data received by the communication unit 130 in the storage unit 30.

The UI display unit 14 causes the touch panel 90 (display) to display the purchase screen based on the purchase UI data 33. The purchase UI data 33 corresponds to display information for the information providing device 1 to display the transaction screen.

The UI display unit 14 extracts information related to display management from the purchase UI data 33, and stores it in the storage unit 30 as the display management information 34. The display management information 34 includes, for example, information specifying a display period described later. The UI display unit 14 constitutes the display unit together with the touch panel 90.

The purchase request reception unit 15 receives an operation of the user U on the touch panel 90 during display of the purchase screen. The purchase request reception unit 15 corresponds to an example of the reception unit. The purchase request reception unit 15 requests the information providing server 300 to purchase the transaction object included in the purchase UI data 33 based on the purchase request operation performed by the user U.

The speed recognition unit 16 recognizes speed of the vehicle V based on a speed detection signal input from the speed sensor 120.

### 3. Configuration of Information Providing Server

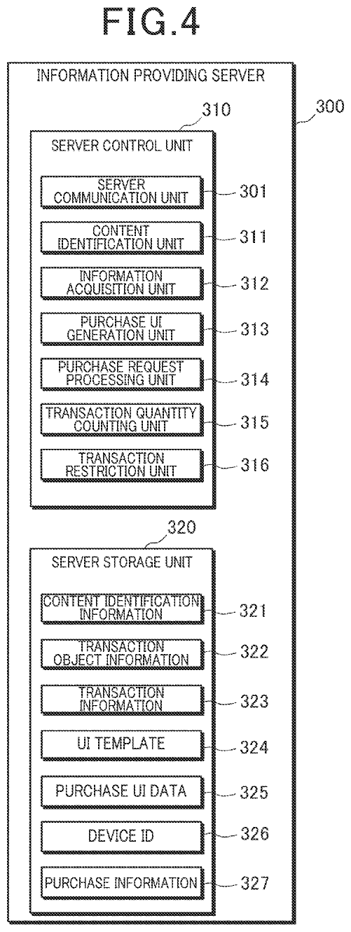

FIG. 4 is a block diagram illustrating a functional configuration of the information providing server 300. The information providing server 300 includes a server control unit 310 for controlling each unit of the information providing server 300, and a server storage unit 320 having a program and data stored therein. The server control unit 310 executes a control program (not shown) stored in the server storage unit 320 by a processor such as a CPU or microcomputer, and implements various functions of the information providing server 300. FIG. 4 shows, as functional units configured by the server control unit 310, a server communication unit 301, a content identification unit 311, an information acquisition unit 312, a purchase UI generation unit 313, a purchase request processing unit 314, a transaction quantity counting unit 315, and a transaction restriction unit 316. These functional units are implemented by collaboration of software and hardware, for example, by the processor executing the program. The server control unit 310 may be equipped with hardware corresponding to these functional units. The server control unit 310 may include an interface circuit (not shown).

The server storage unit 320 is composed of a semiconductor memory device or magnetic recording device, and has stored therein a program and data in a non-volatile manner. The server storage unit 320 has stored therein content identification information 321, transaction object information 322, transaction information 323, a UI template 324, purchase UI data 325, and a device ID 326, in addition to the control program (not shown).

The information providing server 300 communicates with the information providing device 1, content distribution server 410, shopping server 420, and the like through the communication network 500 by a function of the server communication unit 301 according to control of the server control unit 310. The information providing server 300 includes an antenna for connecting to the communication network 500 via the server communication unit 301.

When the information providing device 1 transmits a request for the purchase UI, the content identification unit 311 identifies the content data Ct received by the information providing device 1. The content identification unit 311 acquires identification information or the like specific to the content data Ct, that has received by the information providing device 1, from the content distribution server 410 that transmitted the content data Ct, and stores it as the content identification information 321 in the server storage unit 320.

The information acquisition unit 312 acquires the transaction object information from the content distribution server 410 based on the content identification information 321, and stores the information as the transaction object information 322 in the server storage unit 320. The information acquisition unit 312 acquires the transaction information from the shopping server 420 based on the transaction object information 322, and stores the acquired information as the transaction information 323 in the server storage unit 320.

The purchase UI generation unit 313 generates the purchase UI data to be transmitted to the information providing device 1 based on the transaction information 323. The purchase UI generation unit 313 extracts the information such as the product name, price, and transaction unit quantity included in the transaction information 323, and arranges it in conformity to the UI template 324 to generate data for the purchase screen. The purchase UI generation unit 313 corresponds to an example of the transaction screen generation unit.

The purchase UI generation unit 313 sets the display period as a period during which the information providing device 1 displays the purchase screen. The purchase UI generation unit 313 generates the purchase UI data 325 including information for displaying the purchase screen and information indicating the display period, and stores it in the server storage unit 320. That is, the purchase UI data 325 includes data for the purchase screen, which is the purchase UI, and information specifying the display period.

The display period is a period during which the information providing device 1 can display the purchase screen. The display period may be information specifying a time starting from a time point when the transaction object information is distributed in the content data Ct, or may be information specifying an end of the display period by a date and time.

The purchase screen is a user interface that proposes purchase of the product or service related to the content data Ct to the user U who has listened to the audio of the content. Therefore, after a long time has passed since the user U listened to the audio of the content, it is unlikely that the user U who has seen the purchase screen recalls relationship with contents of the content. For this reason, effect of the purchase screen to arouse purchase motivation of the user U is diminished. Even if the user U is interested in the product or service by the audio of the content, if time passes before the purchase screen is viewed, usefulness of the purchase screen is reduced for the user U.

Consequently, the information providing system 200 adopts an approach in which a period during which the information providing device 1 can display the purchase screen is limited and thereby the usefulness of information to be provided to the user U and the effect to arouse purchase motivation are not reduced.

The UI template 324 is information that defines a configuration of the purchase screen displayed by the information providing device 1, and includes information, such as display position, character size, and font of information to be displayed, and information, such as position and size of a button for receiving a purchase instruction. The UI template 324 includes information that defines display positions of at least the name and price of the transaction object and the button. The UI template 324 is not limited by the specific shopping server 420, the type, price, quantity, or the like of the transaction object, and is information prepared independently of those requirements.

Thus, the purchase UI generation unit 313 generates, by using the UI template 324, a purchase screen in a specific form that is not affected by the shopping server 420 from which the transaction information has been acquired, or the transaction object. In other words, the user U can use the purchase screen having a constant appearance regardless of the type of transaction object or the business operator of a sales source. Therefore, the user U can easily recognize the name and price of the transaction object. The UI template 324 has preferably a simple configuration. For example, it is preferable that the screen does not include information other than the name and price of the transaction object and the button. The configuration has an advantage that the user U driving the vehicle V can recognize the purchase screen without paying strong attention.

The purchase request processing unit 314 receives the purchase request based on the purchase screen from the information providing device 1, accesses the shopping server 420, and performs a process related to the purchase. For example, the purchase request processing unit 314 performs an ordering process of ordering the transaction object by the transaction unit quantity from the shopping server 420. The purchase request processing unit 314 may use personal information on the user U as the name or the like of an orderer. The purchase request processing unit 314 may use information related to settlement means for the user U who uses the information providing device 1 and perform a settlement process. The purchase request processing unit 314 notifies the information providing device 1 of a result of the process related to the purchase.

When the purchase request processing unit 314 receives the purchase request from the information providing device 1, the purchase request processing unit 314 stores purchase information 327 indicating contents of the purchase request in the server storage unit 320 in association with the device ID 326 specific to the information providing device 1 that has made the purchase request.

The transaction quantity counting unit 315 counts a purchased quantity of the transaction object for each transaction object based on the purchase request received by the purchase request processing unit 314. For example, when a purchase request received from the information providing device 1a and a purchase request received from the information providing device 1b by the purchase request processing unit 314 are purchase requests for the same transaction object, the transaction quantity counting unit 315 sums up quantities of those purchase requests.

The transaction restriction unit 316 determines whether the quantity counted by the transaction quantity counting unit 315 has reached the upper limit quantity included in the transaction information. The transaction restriction unit 316 transmits, to the information providing device 1, display restriction information for restricting the display of the purchase screen including a transaction object that has reached the upper limit quantity.

### 4. Operation of Information Providing System

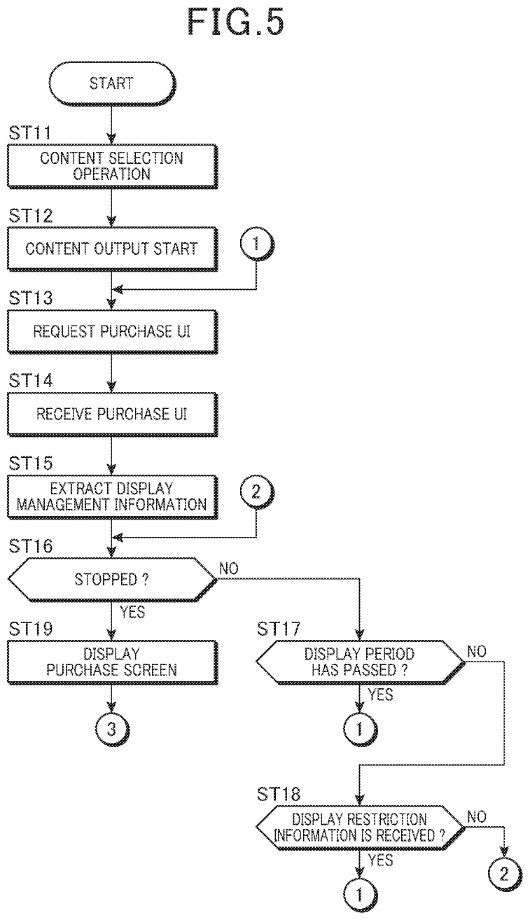

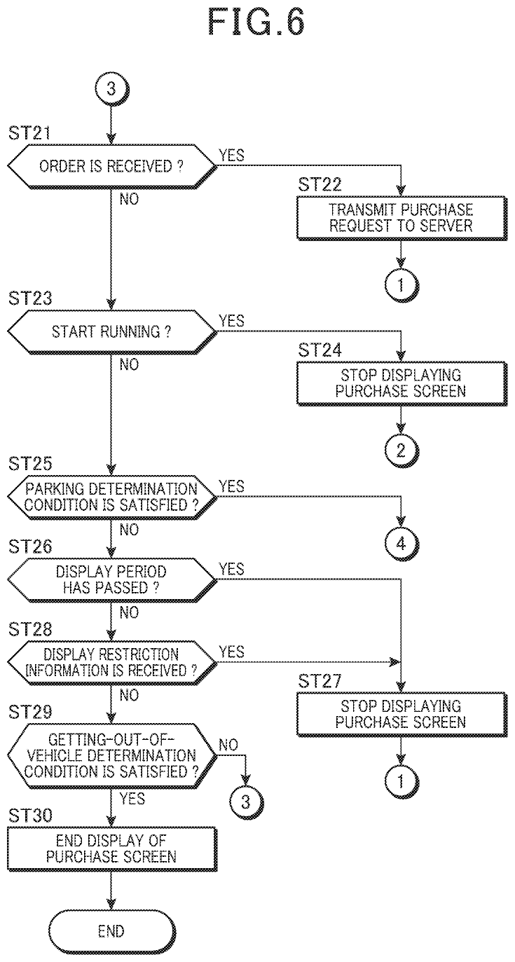

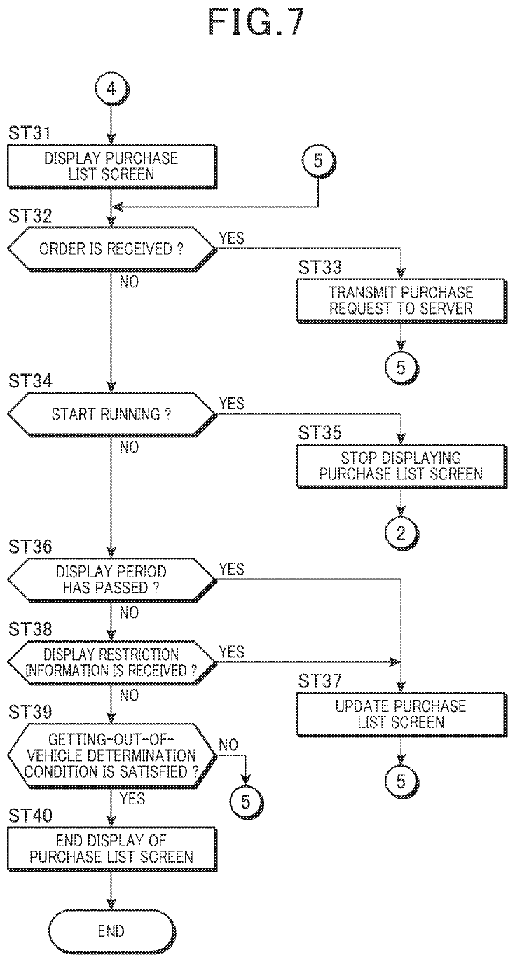

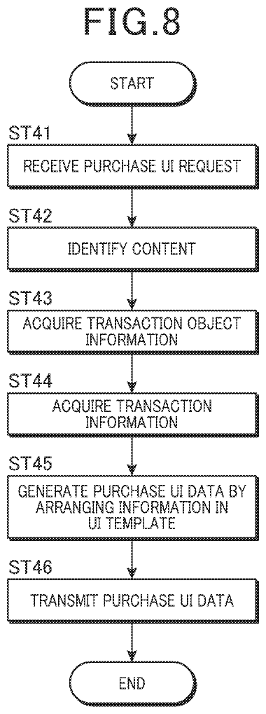

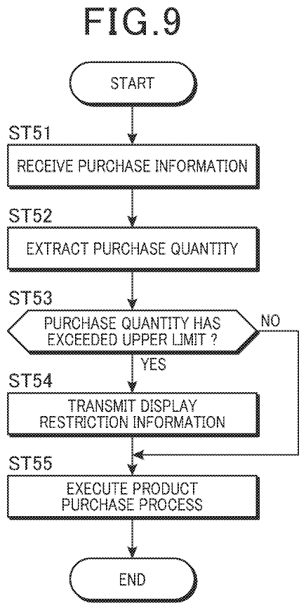

FIGS. 5, 6, and 7 are flowcharts illustrating operation of the information providing device 1. FIGS. 8 and 9 are flowcharts illustrating operation of the information providing server 300, and correspond to the operation of the information providing device 1 shown in FIGS. 5-7. FIG. 10 is a diagram illustrating an example of the purchase screen 600 displayed by the information providing device 1, and FIG. 11 is a diagram illustrating an example of the purchase list screen 610 displayed by the information providing device 1. Operation of the information providing system 200 will be described with reference to those drawings.

In the information providing device 1, when the user U performs an operation to select the content data Ct (step ST11), the content acquisition unit 11 acquires the selected content data Ct from the content distribution server 410, and the content reproduction unit 12 starts reproduction and output of the audio of the content (step ST12).

The UI display unit 14 requests the information providing server 300 to provide the purchase UI related to the content data Ct during reproduction (step ST13). Here, the purchase UI data 33 transmitted by the information providing server 300 in response to the request is received by the communication control unit 13, and stored in the storage unit 30 (step ST14). Here, the communication control unit 13 functions as the transaction screen acquisition unit.

The UI display unit 14 extracts information on display management from the purchase UI data 33, and stores it in the storage unit 30 as the display management information 34 (step ST15).

The UI display unit 14 determines whether the vehicle V has stopped (step ST16). In step ST16, the UI display unit 14 makes a determination based on, for example, speed of the vehicle V recognized by the speed recognition unit 16. In addition, the UI display unit 14 may make a determination based on an operation state of a parking brake (not shown), an operation state of a footbrake (not shown), or the like.

When it is determined that the vehicle V has not stopped (step ST16; NO), the UI display unit 14 refers to the display management information 34, and determines whether the display period has passed (step ST17). When the display period has passed (step ST17; YES), the operation of the control unit 10 returns to step ST13. When the display period has not passed (step ST17; NO), the UI display unit 14 determines whether the display restriction information related to the purchase UI received in step ST14 is received from the information providing server 300 (step ST18). When the display restriction information is received (step ST18; YES), the operation of the control unit 10 returns to step ST13. When the display restriction information is not received (step ST18; NO), the UI display unit 14 returns to step ST16.

When the UI display unit 14 determines that the vehicle V has stopped (step ST16; YES), the UI display unit 14 causes the touch panel 90 to display the purchase screen 600 (step ST19).

The purchase screen 600 shown in FIG. 10 includes a product name display portion 601, a price display portion 602, and an order button 603.

The product name display portion 601 and price display portion 602 are disposed at a position closer to one side of the screen of the touch panel 90, and the order button 603 is disposed on the other. Consequently, the order button 603 does not obstruct visual recognition of information of the product name display portion 601 and price display portion 602.

The purchase screen 600 may have a configuration in which the price display portion 602 is omitted. The product name display portion 601 may display only part of the name included in the transaction information acquired by the information providing server 300 from the shopping server 420. For example, when the name of the transaction object exceeds a limited number of characters, the information providing server 300 may extract characters the number of which is the limited number from the name, arrange them on the UI template 324, and generate data for the purchase screen 600.

Since the user U views the purchase screen 600 after hearing the audio of the content data Ct, the user U has already paid attention to or have knowledge about the transaction object displayed on the product name display portion 601. As a result, even if the purchase screen 600 contains a small amount of information, the purchase screen 600 is sufficiently useful for the purpose for the user U to consider purchase. By omitting information the user U already knows, the screen configuration is excellent in visibility and easy for the user U to operate.

The information providing server 300 may select information to be included in the product name display portion 601 or whether to display the price display portion 602 according to information notified to the user U regarding the transaction object by the video or audio, which are contents of the content data Ct. For example, when a specific product is explained in detail by the audio of the content data Ct, the product name display portion 601 sufficiently functions by only including simplified information. Instead of the name of the transaction object, the product name display portion 601 may display information, such as a product number, a nickname, or a name of privilege such as campaign, conveyed to the user U by the audio of the content data Ct. The information can be included in the transaction information which the information providing server 300 acquires from the content distribution server 410. In this way, reducing the amount of information displayed on the purchase screen 600 makes it possible to provide a user interface having excellent visibility and operability.

When the UI display unit 14 starts display of the purchase screen 600 (step ST19), the purchase request reception unit 15 receives an order operation of the user U on the purchase screen 600 (step ST21). When the purchase request reception unit 15 receives the order (step ST21; YES), the purchase request reception unit 15 transmits a purchase request to the information providing server 300 (step ST22) and returns to step ST13.

When the purchase request reception unit 15 has not received any order (step ST21; NO), the UI display unit 14 determines whether the vehicle V has started running (step ST23). In step ST23, the UI display unit 14 may make a determination based on the speed of the vehicle V as in step ST16.

When the vehicle V has started running (step ST23; YES), the UI display unit 14 stops displaying the purchase screen 600 (step ST24) and returns to step ST16.

When it is determined that the vehicle V has not started running (step ST23; NO), the UI display unit 14 determines whether a parking determination condition is satisfied (step ST25). The parking determination condition is a condition for determining that the vehicle V is continuously parked, in other words, a condition for distinguishing between a temporary stop and parking. The parking determination condition is, for example, that a time during which the vehicle V continues stopping exceeds a preset time. For example, the parking brake of the vehicle V being operated or a shift range of the vehicle V being switched to a P range by an operation of a shift lever may be set as the parking determination condition.

When the parking determination condition is satisfied (step ST25; YES), the UI display unit 14 proceeds to step ST31 described later. When the parking determination condition is not satisfied (step ST25; NO), the UI display unit 14 refers to the display management information 34, and determines whether the display period has passed (step ST26). When the display period has passed (step ST26; YES), the UI display unit 14 stops the display of the purchase screen 600 (step ST27), and returns to step ST13.

When the display period has not passed (step ST26; NO), the UI display unit 14 determines whether the display restriction information related to the purchase UI during display is received from the information providing server 300 (step ST28). When the display restriction information is received (step ST28; YES), the UI display unit 14 proceeds to step ST27.

When the display restriction information is not received (step ST28; NO), the UI display unit 14 determines whether a getting-out-of-vehicle determination condition is satisfied (step ST29).

The getting-out-of-vehicle determination condition is a condition for determining that the user U has got out of the vehicle V. For example, the getting-out-of-vehicle determination condition may include opening and closing of a door on the driver's seat side of the vehicle V, locking of a door lock on the driver's seat side, and recognizing that the user U has got out of the vehicle V by a camera (not shown). In order to detect the getting-out-of-vehicle determination condition, the camera (not shown), a door lock mechanism of the vehicle V, and an ECU for controlling a sensor of door opening and closing may be connected to the information providing device 1.

When the getting-out-of-vehicle determination condition is not satisfied (step ST29; NO), the UI display unit 14 returns to step ST21. When the getting-out-of-vehicle determination condition is satisfied (step ST29; YES), the UI display unit 14 ends the display of the purchase screen 600 (step ST30).

In step ST31, the UI display unit 14 causes the touch panel 90 to display the purchase list screen 610. The purchase list screen 610 is a user interface for purchase having information on the product or the like and the order button, and an example of the purchase screen in the same manner as the purchase screen 600.

The purchase list screen 610 shown in FIG. 11 includes a product list display portion 611 and an order button display portion 612.

The product list display portion 611 includes product name display portions 611a, 611b, and 611c displaying respective products. The product list display portion 611 displays product names based on multiple pieces of purchase UI data 33 received by the information providing device 1 from the information providing server 300. The UI display unit 14 causes the product name display portions 611a, 611b, and 611c to display the product names included in the respective pieces of purchase UI data 33 stored in the storage unit 30. Consequently, the product list display portion 611 displays a list of the plurality of product names.

In the order button display portion 612, order buttons 612a, 612b, and 612c are arranged in association with the product name display portions 611a, 611b, and 611c, respectively, arranged in the product list display portion 611. The order buttons 612a, 612b, and 612c are buttons for instructing purchase of products corresponding to the product name display portions 611a, 611b, and 611c, respectively.

The purchase list screen 610 also displays the purchase UI data 33 whose display period has passed and information on a product (transaction object) indicated by the purchase UI data 33 corresponding to the display restriction information transmitted from the information providing server 300 in the product list display portion 611 and order button display portion 612. For example, the purchase list screen 610 displays a list of information included in all the purchase UI data 33 stored in the storage unit 30 or a predetermined number of pieces of purchase UI data 33 in order from purchase UI data 33 newly received from the information providing server 300. In the product list display portion 611 and order button display portion 612, pieces of information included in the purchase UI data 33 are displayed side by side, for example, in order of time when the purchase UI data 33 was received from the information providing server 300.

The order button display portion 612 displays a guide indicating that an order cannot be placed correspondingly to the products of the purchase UI data 33 whose display period has passed and the purchase UI data 33 for which the display restriction information is transmitted from the information providing server 300. For example, the order button 612a of FIG. 11 displays characters conveying that reception of orders has ended. In this case, even if the user U touches the order button 612a, the information providing device 1 does not accept a purchase request. When the order button 612a is operated, the UI display unit 14 may display a message indicating that no order is accepted on the purchase list screen 610.

The purchase list screen 610 displays information on the products related to the multiple pieces of purchase UI data 33 including information whose display period has already passed. When it is determined that the parking determination condition is satisfied in step ST25, it is estimated that the user U is not in a state of driving the vehicle V soon. Therefore, the user U is in a state where the user U can calmly view information on the touch panel 90. In such a situation, the information providing device 1 can provide the user U with information on the product related to content which the user U viewed or listened to during movement of the vehicle V. This makes it possible for the user U to view, in a relaxed state, information on the product or the like which the user U could not pay attention to while the user U was driving the vehicle. Thus, the information providing device 1 can provide useful information according to the state of the user U.

The purchase request reception unit 15 receives the order operation of the user U on the purchase list screen 610 (step ST32). When the purchase request reception unit 15 receives the order (step ST32; YES), the purchase request reception unit 15 transmits the purchase request to the information providing server 300 (step ST33), and then returns to step ST32.

When the purchase request reception unit 15 has not received any order (step ST32; NO), the UI display unit 14 determines whether the vehicle V has started running (step ST34). In step ST34, the UI display unit 14 can make a determination as in step ST23.

When the vehicle V starts running (step ST34; YES), the UI display unit 14 stops displaying the purchase list screen 610 (step ST35), and returns to step ST16.

When it is determined that the vehicle V has not started running (step ST34; NO), the UI display unit 14 refers to the display management information 34, and determines whether there is purchase UI data 33 whose display period has newly passed (step ST36). If there is purchase UI data 33 whose display period has newly passed (step ST36; YES), the UI display unit 14 updates the purchase list screen 610 (step ST37), and returns to step ST32.

When there is no purchase UI data 33 whose display period has newly passed (step ST36; NO), the UI display unit 14 determines whether the display restriction information related to the purchase UI during display is newly received from the information providing server 300 (step ST38). When the display restriction information is received (step ST38; YES), the UI display unit 14 proceeds to step ST37.

In step ST37, of the information displayed on the purchase list screen 610, the display of the purchase information whose display period has passed and the order buttons 612a, 612b, and 612c corresponding to the purchase information for which the display restriction information is received from the information providing server 300 is switched to a display of the guide indicating that an order cannot be placed.

When the display restriction information is not received (step ST38; NO), the UI display unit 14 determines whether the getting-out-of-vehicle determination condition is satisfied (step ST39). The determination in step ST39 is performed as in step ST29.

When the getting-out-of-vehicle determination condition is not satisfied (step ST39; NO), the UI display unit 14 returns to step ST32. When the getting-out-of-vehicle determination condition is satisfied (step ST39; YES), the UI display unit 14 ends the display of the purchase list screen 610 (step ST40).

Data for displaying the purchase list screen 610 is generated, for example, by the purchase UI generation unit 313 of the information providing server 300, and transmitted to the information providing device 1. In this configuration, when the purchase list screen 610 is updated in step ST37, data for the updated purchase list screen 610 is generated by the purchase UI generation unit 313, and is transmitted from the information providing server 300 to the information providing device 1. In addition, the UI display unit 14 may generate and update data for the purchase list screen 610 based on the purchase UI data 33.

FIG. 8 shows an operation in which the information providing server 300 generates a user interface.

When the request for the purchase UI is received from the information providing device 1 (step ST41), the content identification unit 311 identifies the content data Ct received by the information providing device 1 (step ST42). The information acquisition unit 312 acquires transaction object information regarding the content data Ct identified by the content identification unit 311 from the content distribution server 410 (step ST43), and acquires transaction information from the shopping server 420 based on the transaction object information (step ST44).

The purchase UI generation unit 313 generates the purchase UI data 325 by arranging the information included in the transaction information 323 in the UI template 324 (step ST45), and transmits it to the information providing device 1 (step ST46).

FIG. 9 shows an operation in which the information providing server 300 processes the purchase request.

When the purchase request is received from the information providing device 1 (step ST51), the purchase request processing unit 314 extracts a purchase quantity from the purchase request (step ST52). The transaction quantity counting unit 315 sums the extracted quantity and a quantity of a purchase request already received for the same transaction object, and compares the total with the upper limit quantity (step ST53). When the purchase-requested quantity reaches the upper limit quantity of the transaction object (step ST53; YES), the transaction restriction unit 316 generates display restriction information and transmits it to all information providing devices 1 having purchase UI data related to the transaction object that has reached the upper limit quantity (step ST54). Then, the purchase request processing unit 314 performs an order process for the shopping server 420 according to the purchase request received from the information providing device 1 (step ST55). When the purchase-requested quantity does not reach the upper limit quantity of the transaction object (step ST53; NO), the server control unit 310 proceeds to step ST55 without performing the process in step ST54.

### 5. Other Embodiments

In the above embodiment, the four-wheeled vehicle V is exemplified as the movable body of the present invention, but the present invention is applicable to various passenger movable bodies, such as a two-wheeled vehicle, a flying body, and a ship.

In the above-embodiment, as an example of content, the configuration of outputting the audio of radio broadcasting from the speaker 91 is described, but the content may include video. A device that reproduces the content is not limited to the speaker 91, and may be headphones or earphones. The information providing device 1 may receive the purchase request of the user U based on the purchase screen 600 or purchase list screen 610 by recognizing the voice of the user U by the microphone 92.

The above embodiment exemplifies the configuration in which the information providing device 1 communicates with the information providing server 300 by using the communication unit 130, but the information providing device 1 may include a built-in wireless communication device. The information providing device 1 is not limited to one fixedly installed on the vehicle V, and, for example, a transportable device, such as a smartphone and a mobile phone, may be used as the information providing device 1.

FIGS. 3 and 4 are schematic diagrams showing the functional configurations of the information providing device 1 and information providing server 300 by classifying according to main processing contents, in order to facilitate understanding of the invention of the present application, and the configurations of the information providing device 1 and information providing server 300 may be configured according to other respective classifications. Processing of each component may be executed by one hardware unit, or may be executed by a plurality of hardware units. Processing of each component shown in FIGS. 5-9 may be executed by one program or may be executed by a plurality of programs.

### 6. Configuration Supported by Above Embodiments

The above embodiments are specific examples of the following configurations.

(Article 1) An information providing system comprising a content distribution server for distributing content data and at least one movable body terminal device configured to be able to communicate with the distribution server and installed on a movable body, wherein: the movable body terminal device includes a terminal device-side processor, wherein the terminal device-side processor functions as a content acquisition unit for acquiring the content data, and a content reproduction unit for reproducing and outputting the content data; and the distribution server includes a server-side processor, wherein the server-side processor functions as an information acquisition unit for acquiring transaction information for trading at least one transaction object including a product or service related to the content data, and a transaction screen generation unit for generating a transaction screen enabling trading of the transaction object based on the transaction information, wherein: the terminal device-side processor functions as a display unit for displaying the transaction screen on a display provided on the movable body terminal device, and a reception unit for receiving a transaction request based on the transaction screen; and the server-side processor generates the transaction screen in a specific form independent of a type and contents of the transaction object by a function of the transaction screen generation unit.

According to the information providing system of Article 1, since the transaction screen enabling trading of the transaction object related to the content data is made in the specific form independent of the type and contents of the transaction object, the user can easily recognize the information displayed on the transaction screen. This makes it possible to provide a user interface with excellent operability when the product or service of the transaction object is traded.

(Article 2) The information providing system according to Article 1, wherein the terminal device-side processor displays the transaction screen on the display in a state where the movable body is stopping and stops displaying the transaction screen while the movable body is moving.

According to the information providing system of Article 2, the user who, for example, operates or drives the movable body is allowed to visually recognize the transaction screen so as not to obstruct operation or driving.

(Article 3) The information providing system according to Article 1 or 2, wherein: the content data includes transaction object information indicating a name or type of the transaction object; the transaction screen is a screen in which the transaction information for trading the transaction object related to the transaction object information is disposed in the specific form; and the terminal device-side processor does not display the transaction screen on the display after a preset display period has passed since the transaction object information included in the content data was reproduced by a function of the content reproduction unit.

According to the information providing system of Article 3, it is possible to ensure usefulness of information provided to the user by displaying the transaction screen before the user's memory related to the transaction object information fades.

(Article 4) The information providing system according to Article 3, wherein the terminal device-side processor acquires information specifying the display period together with the transaction screen.

According to the information providing system of Article 4, since the display period is acquired together with the transaction screen, it is possible to ensure control of display of the transaction screen based on the display period.

(Article 5) The information providing system according to any one of Articles 1 to 4, wherein: the transaction information acquired by the server-side processor by a function of the information acquisition unit includes information indicating an upper limit quantity of the transaction object; the information providing system includes the plurality of movable body terminal devices; and the server-side processor functions as a transaction quantity counting unit for counting a transaction quantity of the transaction requests which the terminal device-side processors of the plurality of movable body terminal devices have received by the reception unit, and a transaction restriction unit for restricting the transaction requests to be received by the movable body terminal devices by the reception unit when the transaction quantity counted by the transaction quantity counting unit reaches the upper limit quantity of the transaction object.

According to the information providing system of Article 5, the transaction based on the transaction screen is restricted according to the upper limit quantity of the transaction object. For this reason, it is possible to avoid a situation in which the transaction is unsuccessful due to insufficient inventory of the transaction object, and to smoothly conduct the transaction using the transaction screen.

(Article 6) The information providing system according to Article 2, wherein: the transaction screen includes a first transaction screen and a second transaction screen, wherein the first transaction screen is a screen in which the transaction information on one of the transaction objects is disposed in the specific form, and the second transaction screen is a screen in which the transaction information on the plurality of transaction objects is displayed as a list; and the terminal device-side processor displays the first transaction screen on the display when the movable body stops from a moving state, and displays the second transaction screen on the display when the movable body is estimated to continue stopping.

According to the information providing system of Article 6, the user who operates or drives the movable body is allowed to visually recognize the transaction screen so as not to obstruct operation or driving. When the user views information between operations or between driving, a user interface with excellent visibility is provided, and when the user can calmly visually recognize information, a user interface with a large amount of information is provided. Thus, the appropriate user interfaces in both operability and amount of information can be provided depending on the user's state.

(Article 7) The information providing system according to Article 6, wherein the terminal device-side processor displays the transaction information on the transaction object for which the transaction request is not accepted on the second transaction screen together with information indicating that the transaction request is not accepted.

According to the information providing system of Article 7, when the user can calmly visually recognize information, information is provided even for the transaction object for which the transaction request is not accepted, and furthermore the user is notified that the transaction request is not accepted. This makes it possible to provide the user with more and accurate information on the transaction object related to the content.

(Article 8) A server comprising a processor, wherein the processor functions as: a server communication unit for communicating with a movable body terminal device, the movable body terminal device being installed on a movable body and acquiring content data from a content distribution server to reproduce and output; an information acquisition unit for acquiring transaction information for trading a transaction object including a product or service related to the content data; and a transaction screen generation unit for generating display information for the movable body terminal device to display a transaction screen enabling trading of the transaction object based on the transaction information, wherein: the processor transmits the display information to the movable body terminal device by the server communication unit; and the transaction screen generation unit generates the transaction screen in a specific form independent of a type and contents of the transaction object.

According to the server of Article 8, the transaction screen enabling trading of the transaction object related to the content data is generated in the specific form independent of the type and contents of the transaction object. The user who views the transaction screen can easily recognize the information displayed on the transaction screen. This makes it possible to provide a user interface with excellent operability when the product or service of the transaction object is traded.

(Article 9) An information providing device installed on a movable body, the information providing device comprising a processor, wherein the processor functions as: a content acquisition unit for acquiring content data from a content distribution server that distributes the content data; a content reproduction unit for reproducing and outputting the content data; a transaction screen acquisition unit for acquiring display information on a transaction screen for trading a transaction object including a product or service related to the content data; a display unit for displaying the transaction screen based on the display information; and a reception unit for receiving a transaction request based on the transaction screen, wherein the transaction screen which the processor displays by the display unit is a screen in a specific form independent of a type and contents of the transaction object.

According to the information providing device of Article 9, since the transaction screen enabling trading of the transaction object related to the content data is displayed in the specific form independent of the type and contents of the transaction object, the user can easily recognize the information displayed on the transaction screen. This makes it possible to provide a user interface with excellent operability when the product or service of the transaction object is traded.

(Article 10) A control method of an information providing device executed by a processor of the information providing device installed on a movable body, the control method of the information providing device comprising: acquiring content data from a content distribution server that distributes the content data; reproducing and outputting the content data; acquiring display information on a transaction screen for trading a transaction object including a product or service related to the content data; displaying the transaction screen on a display based on the display information; and receiving a transaction request based on the transaction screen, wherein the transaction screen displayed on the display is a screen in a specific form independent of a type and contents of the transaction object.

According to the control method of the information providing device of Article 10, since the transaction screen enabling trading of the transaction object related to the content data is displayed in the specific form independent of the type and contents of the transaction object, the user can easily recognize the information displayed on the transaction screen. This makes it possible to provide a user interface with excellent operability when the product or service of the transaction object is traded.

(Article 11) A recording medium non-temporary, computer-readable, and having recorded a control program of an information providing device executed by a processor of the information providing device disposed on a movable body, wherein the control program causes the processor to: acquire content data from a content distribution server that distributes the content data; reproduce and output the content data; acquire display information on a transaction screen for trading a transaction object including a product or service related to the content data; display the transaction screen on a display based on the display information; and receive a transaction request based on the transaction screen, wherein the transaction screen displayed on the display is a screen in a specific form independent of a type and contents of the transaction object.

According to the recording medium of Article 11, since the transaction screen enabling trading of the transaction object related to the content data is made in the specific form independent of the type and contents of the transaction object, the user can easily recognize the information displayed on the transaction screen. This makes it possible to provide a user interface with excellent operability when the product or service of the transaction object is traded.

### REFERENCE SIGNS LIST

1, 1a, 1b . . . Information providing device (movable body terminal device)
10 . . . Control unit
11 . . . Content acquisition unit
12 . . . Content reproduction unit
13 . . . Communication control unit (transaction screen acquisition unit)
14 . . . UI display unit (display unit)
15 . . . Purchase request reception unit
16 . . . Speed recognition unit
30 . . . Storage unit
31 . . . Control program
32 . . . Content data
90 . . . Touch panel
91 . . . Speaker
130 . . . Communication unit
140 . . . Navigation device
200 . . . Information providing system
300 . . . Information providing server (server)
301 . . . Server communication unit
310 . . . Server control unit
311 . . . Content identification unit
312 . . . Information acquisition unit
313 . . . Purchase UI generation unit (transaction screen generation unit)
314 . . . Purchase request processing unit
315 . . . Transaction quantity counting unit
316 . . . Transaction restriction unit
320 . . . Server storage unit
321 . . . Content identification information
322 . . . Transaction object information
323 . . . Transaction information
324 . . . UI template
325 . . . Purchase UI data
326 . . . Device ID
327 . . . Purchase information
410 . . . Content distribution server
420 . . . Shopping server
600 . . . Purchase screen (transaction screen, first transaction screen)
601 . . . Product name display portion
602 . . . Price display portion
603 . . . Order button
610 . . . Purchase list screen (transaction screen, second transaction screen)
611 . . . Product list display portion
612 . . . Order button display portion
Ct . . . Content data
U . . . User
V . . . Vehicle (movable body)

What is claimed is:

1. An information providing system comprising a content distribution server for distributing content data and at least one movable body terminal device configured to be able to communicate with the distribution server and installed on a movable body, wherein:
the movable body terminal device includes a terminal device-side processor,
wherein the terminal device-side processor functions as
a content acquisition unit for acquiring the content data, and
a content reproduction unit for reproducing and outputting the content data; and
the distribution server includes a server-side processor,
wherein the server-side processor functions as
an information acquisition unit for acquiring transaction information for trading at least one transaction object including a product or service related to the content data, and
a transaction screen generation unit for generating a transaction screen enabling trading of the transaction object based on the transaction information, wherein:
the terminal device-side processor functions as
a display unit for displaying the transaction screen on a display provided on the movable body terminal device, and
a reception unit for receiving a transaction request based on the transaction screen; and
the server-side processor generates the transaction screen in a specific form independent of a type and contents of the transaction object by a function of the transaction screen generation unit.

2. The information providing system according to claim 1,
wherein the terminal device-side processor
displays the transaction screen on the display in a state where the movable body is stopping and stops displaying the transaction screen while the movable body is moving.

3. The information providing system according to claim 1, wherein:
the content data includes transaction object information indicating a name or type of the transaction object;
the transaction screen is a screen in which the transaction information for trading the transaction object related to the transaction object information is disposed in the specific form; and
the terminal device-side processor
does not display the transaction screen on the display after a preset display period has passed since the transaction object information included in the content data was reproduced by a function of the content reproduction unit.

4. The information providing system according to claim 3,
wherein the terminal device-side processor
acquires information specifying the display period together with the transaction screen.

5. The information providing system according to claim 1, wherein:
the transaction information acquired by the server-side processor by a function of the information acquisition unit includes information indicating an upper limit quantity of the transaction object;
the information providing system
includes the plurality of movable body terminal devices; and
the server-side processor functions as
a transaction quantity counting unit for counting a transaction quantity of the transaction requests which the terminal device-side processors of the plurality of movable body terminal devices have received by the reception unit, and
a transaction restriction unit for restricting the transaction requests to be received by the movable body terminal devices by the reception unit when the transaction quantity counted by the transaction quantity counting unit reaches the upper limit quantity of the transaction information.

6. The information providing system according to claim 2, wherein:
the transaction screen includes a first transaction screen and a second transaction screen, wherein
the first transaction screen is a screen in which the transaction information on one of the transaction objects is disposed in the specific form, and
the second transaction screen is a screen in which the transaction information on the plurality of transaction objects is displayed as a list; and
the terminal device-side processor
displays the first transaction screen on the display when the movable body stops from a moving state, and displays the second transaction screen on the display when the movable body is estimated to continue stopping.

7. The information providing system according to claim 6,
wherein the terminal device-side processor
displays the transaction information on the transaction object for which the transaction request is not accepted on the second transaction screen together with information indicating that the transaction request is not accepted.

8. A control method of an information providing device executed by a processor of the information providing device installed on a movable body, the control method of the information providing device comprising:
acquiring content data from a content distribution server that distributes the content data;
reproducing and outputting the content data;
acquiring display information on a transaction screen for trading a transaction object including a product or service related to the content data;
displaying the transaction screen on a display based on the display information; and
receiving a transaction request based on the transaction screen,
wherein the transaction screen displayed on the display is a screen in a specific form independent of a type and contents of the transaction object.

9. A recording medium non-temporary, computer-readable, and having recorded a control program of an information providing device executed by a processor of the information providing device disposed on a movable body,
wherein the control program causes the processor to:
acquire content data from a content distribution server that distributes the content data;
reproduce and output the content data;
acquire display information on a transaction screen for trading a transaction object including a product or service related to the content data;
display the transaction screen on a display based on the display information; and
receive a transaction request based on the transaction screen,
wherein the transaction screen displayed on the display is a screen in a specific form independent of a type and contents of the transaction object.
